(19) United States
(12) Patent Application Publication
(10) Pub. No.: US 2015/0002352 A1
(43) Pub. Date: Jan. 1, 2015

(54) MANUFACTURING METHOD OF A DIELECTRIC MATERIAL AND ITS APPLICATIONS TO MILLIMETER-WAVES BEAM FORMING ANTENNA SYSTEMS

(71) Applicant: CANON KABUSHIKI KAISHA, Tokyo (JP)

(72) Inventors: Hervé Merlet, Rennes (FR); Phillippe Le Bars, La Dominelais (FR); Olivier Lafond, Gosne (FR); Mohammed Himdi, Rennes (FR)

(21) Appl. No.: 14/362,901

(22) PCT Filed: Dec. 7, 2012
(86) PCT No.: PCT/EP2012/074827

§ 371 Date: Jun. 4, 2014

(30) Foreign Application Priority Data
Dec. 7, 2011 (GB) 1121036.6

(51) Int. Cl. H01Q 15/08; B29C 43/18; B29C 43/00; H01Q 19/06; B29C 43/32

(52) U.S. Cl. CPC H01Q 15/08; H01Q 19/065; B29C 43/32; B29C 43/003; B29C 43/18; B29K 2105/04
USPC 343/753; 343/910; 264/138; 264/320; 264/321; 264/259; 501/134

(57) ABSTRACT

The invention concerns a manufacturing method of a new type of dielectric material having a predefined variable permittivity resulting from the manufacturing process. Main characteristic of the manufacturing method is that in a first step homogeneous dielectric material (100) is shaped in at least a direction and subsequently at least a part thereof is formed so that the resulting dielectric material body (102) has the predefined variation in permittivity in said at least one direction. Said forming step may advantageously comprise sub-steps of deforming at least a part of the shaped dielectric material body and fixing the so deformed dielectric material body. The manufacturing steps are adapted so to induce a predefined variation in permittivity corresponding but not limited to a certain law (e.g. Luneburg, Maxwell, . . . ). The invention further concerns a manufacturing method of an electromagnetic lens that can be used in a millimeter-waves multi-beam forming antenna system where said electromagnetic lens is composed of the new type of dielectric material.

The invention relates to a new type of dielectric material being a monolithic continuum and having a predefined variation in dielectric permittivity.

The invention also relates to methods of manufacturing such a new type of dielectric material and to industrial applications for this new type of dielectric material, in particular in the field of communication devices.

Communication devices, including digital cameras and high-definition digital camcorders are ubiquitously used and require an increasingly higher quality of services.

There is a growing need for reliable communication devices with high recording capacities that are user-friendly and offer high image quality.

When images such as video and photographs are viewed on a display device including a HD (high-definition) television, the required bit rates for the transmission of data between the imaging device and the display device are in the range of several gigabits per second (Gbps).

Similar bit rates are necessary for the transmission of data between an imaging device and a storage device or physical carrier dedicated to the storage of multimedia data (audio and video data).

To prevent loss of quality during the transfer of images, a digital wire link such as an HDMI (high-definition multimedia interface) cable is at least necessary.

Indeed high-definition non-compressed multimedia data are transmitted in raw mode, it being understood that almost no processing and no compression is performed.

Raw data as recorded by the sensor of the imaging device can therefore be rendered without loss of quality.

Moreover, in home communication, raw data needs also to be transmitted almost in real time.

However, the use of a wired link in home communications systems has several drawbacks.

For example, a wired link between a camera and a television set has several limitations.

On the television set side, the connection systems may be difficult to access or may even not be available.

On the camera side, the connection systems are very small in size and may be concealed by covers, thereby making it difficult to connect the cable. In addition, it can be very difficult to move the camera or the screen when all devices are connected.

Similarly, in case cables are integrated in the walls of a house it is impossible to modify the installation. One approach for overcoming these drawbacks is the use of wireless connections between the communication devices.

However, said systems need to support data bit rates in the order of several Gigabits per second (Gbps). WiFi systems are operating in the 2.4 GHz and 5 GHz radio bands (as stipulated by the 802.11.a/b/g/n standard) and are not suited to reach the target bit rates. It is therefore necessary to use communications systems in a radio band of higher frequencies. The radio band around 60 GHz is a suitable candidate. When using an extensive bandwidth, 60 GHz radio communications systems are particularly well suited to transmit data at very high bit rates. In order to obtain high quality radio communications (i.e. low error bit rate) and sufficient radio range between two communication devices without having to transmit at unauthorized power levels, it is necessary to use directional (or selective) antennas enabling line of sight (LOS) transmission. Consequently, narrow beam forming techniques are necessary for wireless transmission with high throughput bit rate.

During the discovery phase, each pair of nodes of the wireless network has to initiate the communication parameters. It is therefore necessary to configure the antenna angle in order to obtain the best quality with the radio frequency (RF) link.

Communication parameters can be transmitted with a low bit rate and therefore allow decreasing needs in the budget of the RF link (e.g. antenna gain). This in turn allows a wide antenna beam to be formed in order to detect all the nodes within reach.

Consequently, the antenna has to form both a narrow and a wide beam during subsequent phases.

The antenna needed in the above-mentioned applications shall therefore be reconfigurable so as to obtain a narrow beam in azimuth, while having a large beam in elevation.

The so-called smart antennas or reconfigurable antennas are used to reach the distances required by audio and video applications. A smart antenna qiy comprises a network (e.g. an array) of radiating elements distributed on a support. Each radiating element is electronically controlled in phase and power (or gain) in order to form a narrow beam or set of beams in sending and reception mode. Each beam can be steered and controlled. Consequently, this requires a dedicated phase controller and a power amplifier for each antenna element which increases the cost of the antenna.

In order to obtain a narrow beam, several antenna elements have to be powered, which may therefore result in significant consumption of energy. Power consumption is a serious handicap, especially for battery-powered portable devices.

In addition, the geometrical dimensions of the smart antenna are also a strong limitation to small portable devices.

The smart antennas known in the prior art comprise a network of radiating elements (for example 16) laid out in a square array on a substrate. The radiating elements have each a dimension of half the wavelength (i.e. 2.5 mm in case of 60 GHz range) and the space between the antenna elements has to be at least of one quarter of the wavelength. Consequently, the surface of a smart antenna is rather large, which is not very convenient for being integrated in portable devices. This leads to high costs, particularly when the materials used in the manufacture of the antenna comprise a substrate based on semiconductor technology. In the latter case, the final costs for mass market production of portable devices may be too high.

A planar steerable antenna using PCB patch is proposed by Sibeam (product SB9220/SB9210). This antenna sends energy in a large set of predefined directions. The number of possible directions is a function of the number of radiating elements.

However, many radiating elements are needed for such a design. Mutual inductance between the antenna elements is an important drawback for this technique and results in waste of energy through coupling. Also, the inherent symmetry causes energy to be sent in undesired directions. Another drawback is the necessity to adapt both the amplitude and the phase of the signal to be sent to each radiating element. Such an operation is costly at 60 GHz frequency.

In a known manner, spherical electromagnetic lenses are used in steerable antennas. The basic concepts are described by R. Lüneburg (Mathematical Theory of Optics, Cambridge University Press, 1964). Spherical lenses are composed of dielectric materials having a gradient of decreasing refractive index. The relative dielectric constant of the lens (commonly referred to as Lüneburg lens) follows the following rule:

∈ᵣ(r)=2−(r/R)², for r=0, . . . ,R;

and varies with the radial position r in the lens. Good control of the beam in azimuth is obtained through radiating into the lens several thin beams along its edges. The Lüneburg lens can be used in many applications, mainly those comprising radar reflectors and high altitude platform receivers. Spherical shapes of the lens are mainly used.

Two implementation techniques of the Lüneburg lens are known and consist either in drilling holes as described in S. Rondineau, M. Himdi, J. Sorieux, A Sliced Spherical Lüneburg Lens, IEEE Antennas Wireless Propagat. Lett., 2 (2003), 163-166, or using a plurality of dielectric materials having different discrete dielectric constants (referred to also as permittivity) as described in WO 2007/003653.

As to the first cited implementation technique above, the Lüneburg law is approximated by drilling holes in homogeneous dielectric material. Air is filling up these holes and locally changes the dielectric permittivity according to the number and positions of the drilled holes. In order to obtain a good approximation of the Lüneburg law, several thousands of holes may be necessary. The resulting density of the holes becomes important particularly in the vicinity of the outer boundary of the lens. Consequently the resulting electromagnetic lens is fragile and very difficult to manufacture. Particularly when the dimensions of the electromagnetic lens are small, mass production thereof is difficult to optimize in terms of cost and time.

As to the second cited implementation technique, the dielectric material body is a layered superposition of different homogeneous dielectric materials. Each layer has a different permittivity constant. However, the material body is not monolithic and consequently certain air gaps may appear in between the layers of dielectric material that compose the dielectric material body. This results in decreased performance and may affect the quality of the final product whenever the dielectric material body is used as electromagnetic lens. Furthermore, the use of materials having different discrete permittivity does not make it possible to have a smooth variation in permittivity within the dielectric material body.

Consequently, these two manufacturing techniques fail to produce high quality dielectric material bodies and electromagnetic lenses. Moreover such antenna systems are difficult to assemble and have high energy consumption.

Available commercial products are mostly alternatives of satellite dishes, being able to emit radiations at a low elevation. However, they are not suitable for applications requiring a constant angle in elevation and beam steering in azimuth.

Furthermore, beam forming and beam steering techniques are described in prior art. In WO2009013248, an antenna system is considered based on a lens being able to configure either a narrow beam or a sector-shaped (or wide) beam. The antenna system has a radiation diagram that can be reconfigured. This antenna is well adapted for the automotive radar application, but presents limitations for a wireless portable device. Their use in portable devices is not compatible due to the form and volume taken by the spherical or hemispherical lens. It is also difficult to manufacture said antennas from an industrial point of view. In particular, the assembly of the concentric homogeneous dielectric shells forming a spherical lens or hemispherical lens remains a problem. The number of the antenna sources in a given plane is also a strong limitation, particularly when considering the requirements for the azimuth angle of 160° and 10° for the narrow beam in 16 different directions. This implementation is thus not suitable.

Further manufacturing methods are described in U.S. Pat. No. 6,549,340 (B1) and U.S. Pat. No. 6,592,788 (B1).

In U.S. Pat. No. 6,549,340 (B1), a dielectric lens is manufactured by injection moulding of an expandable material. The dielectric material body is composed of a synthetic resin, a foaming agent and a conditioner of the dielectric constant. The dielectric material is composed of a granular agglomerate whose dielectric properties are defined by a homogeneous granule distribution. The granules are thermoplastic materials whose boundaries are welded together to consolidate the total material body. This homogeneous dielectric material body forms a Lüneburg lens being the focusing device of an antenna system that is to be used in satellite applications. The manufacturing method is adapted to produce spherical lenses but in turn, the implementation thereof needs heavy tools and is very costly. Moreover the lens is realized by applying several layers of homogeneous dielectric materials to approximate the Lüneburg or Maxwell Law and consequently does not solve the problem of air gaps between the layers.

In U.S. Pat. No. 6,592,788 (B1) a manufacturing method of a dielectric lens is described that is based on injection moulding of an expandable material comprising a synthetic resin, a foaming agent and a conditioner of the dielectric constant. This method is adapted to manufacture a lens with constant permittivity and consequently does not allow the manufacturing of an electromagnetic lens where the dielectric material body implements a given law such as a Lüneburg Law or a Maxwell Law.

The invention has been devised with the foregoing in mind.

According to a first aspect, the invention concerns a manufacturing method of manufacturing a dielectric material body having a predefined variation in dielectric permittivity in at least one direction, the method comprising steps of shaping in at least one direction at least one part of a dielectric material body and forming at least partially the shaped dielectric material body, said steps being adapted so that the shaped and formed dielectric material body has a predefined variation in dielectric permittivity in said at least one direction.

It is to be emphasized here that the dielectric material body is formed from a single dielectric material block or part in opposition to known techniques where the dielectric material body is mainly the result of a layered superposition block-wise superposition. The single material body according to the invention does therefore not suffer from the possible air-gaps in between the layers of various dielectric permittivity values as in the prior art.

Here, the single material body that is obtained through the manufacturing method has a variation in permittivity which results from the transformation imparted by the steps of the method to the single material block or part present at the beginning of the process.

This original single material block has an original dielectric permittivity and the steps of the method applied to this material block modify the dielectric permittivity within the material so as to lead to a desired variation in permittivity that is different from the original permittivity.

In contrast, in the prior art, the original dielectric permittivity values present in the different layers prior to their assembly do not change after the assembly.

The single dielectric material body may be viewed as a monolithic continuum.

The shaping step and the forming step cooperate during the manufacturing to induce the predefined variation in permittivity. The forming step may further comprise a sub-step of deforming at least partially the shaped dielectric material body. The deforming sub-step of the shaped dielectric material body makes it possible to substantially obtain the final shape of the material body (e.g. a spherical or cylindrical shape).

The forming step may also comprise a sub-step of fixing the shaped dielectric material body. Particularly, in case the dielectric material body comprises elastical or flexible material, the shaped and deformed dielectric material body is fixed to be maintained in its final form.

In a possible application, the deforming sub-step comprises the application of compression forces on at least one part of the shaped dielectric material body. The application of compression forces during the deforming sub-step is part of the preferred implementation of the manufacturing method. Both elastic and non-elastic (rigid) dielectric materials may be compressed to lead to a final form of the shaped dielectric material body. It is to be noted that a rigid or non-elastic dielectric material within the meaning of the invention is a dielectric material that needs to be heated so as to be subsequently shaped.

According to a possible feature, the shaped dielectric material body may at least partially be enclosed by an enclosure that compresses at least partially the deformed dielectric material body. A soft or elastic dielectric material body needs to be mechanically maintained, subsequently to the deforming sub-step.

According to a further possible feature, the enclosure encapsulating at least partially the shaped dielectric material body comprises at least two plates compressing together at least partially the deformed dielectric material body. This compression device is particularly simple and easy to implement.

In a possible implementation of the manufacturing method, the fixing sub-step of the fixing shaped dielectric material body comprises fastening together at least two parts composing the enclosure. A shaped and formed soft dielectric material needs in particular to be maintained thanks to an enclosure as the forming step substantially takes place in the elastic domain of the dielectric material.

According to another possible feature, the deforming sub-step comprises the application of dilatation or expansion forces on at least one part of the shaped dielectric material body. According to a further possible feature, the deforming sub-step comprises heating of at least one part of the shaped dielectric material body. Heating is substantially used to control and to facilitate the deformation of the shaped dielectric material body. Heating is necessary during the deforming sub-step applied to rigid or non-elastic dielectric materials.

According to a possible feature, the shaping step comprises cutting away at least one part of the dielectric material body in at least one direction. The variation in dielectric permittivity is mainly determined by the shaping step. Alternatively, the shaping step may advantageously comprise moulding of at least one part of the dielectric material body in at least one direction.

Thus, it may be easier to reproduce the manufacturing of the shaped dielectric material body with accuracy.

According to a possible feature, the dielectric material is substantially homogeneous and the shape of the dielectric material body is chosen so as to be substantially correlated with the variation in permittivity to be achieved in at least one direction of said dielectric material body.

In a possible implementation, the dielectric material is a foam material. Such a material proves to be easy to shape.

According to a further possible feature, the dielectric material body has a cylindrical shape. The dielectric permittivity variation law is thus the same in any radial direction.

In case the dielectric material body has a cylindrical shape, the shaping step of at least one part of the dielectric material body in at least one direction comprises adjusting the variation in height of said cylindrical dielectric material body in said at least one direction, in order for said variation to substantially correspond to the predefined law of variation in permittivity of the dielectric material body.

Furthermore, in case the dielectric material body has a cylindrical shape, the shaping step of at least one part of the dielectric material body in at least one direction comprises adjusting the variation in height of said cylindrical dielectric material body in said at least one direction in order for said variation to substantially correspond to a discrete approximation of the predefined law of variation in permittivity of the dielectric material body. Thus, stepwise variations in the dielectric permittivity can be achieved through this manufacturing method. Other variations such as a variable gradient and any other approximation (e.g. by using spline functions) of the desired law can also be obtained thanks to the manufacturing method.

According to another aspect, the invention also concerns a new type of dielectric material body made of a single dielectric material body and having a predefined variation in dielectric permittivity.

According to a possible feature, said dielectric material body comprises gas cavities (or alveolus) of variable size in at least one direction. Gradient wise variations of the dielectric permittivity can also be achieved through the manufacturing method.

Furthermore, the dielectric material body has a variation in size of the gas cavities (or alveolus) that is adapted to substantially correspond to the predefined law of variation in permittivity in at least one direction of the dielectric material body. This is a new type of dielectric material wherein the variation in size of the gas cavities can be controlled by adjusting the predefined law of variation in permittivity.

According to a possible feature, the dielectric material body has a variation in size of the gas cavities (or alveolus) that is adapted to substantially correspond to a discrete approximation of a given law of variation in permittivity in at least one direction of the dielectric material body. New types of dielectric material can be obtained having a variation in size of the gas cavities according to any type of discrete approximation of the law of variation in permittivity.

According to another possible feature, the dielectric material body comprises gas cavities (or alveolus) and has at least two regions with gas cavities (or alveolus) of different size in each region. No assembly of different materials is required to provide a variation in permittivity.

According to a possible feature, the gas cavities have been previously compressed or expanded differently according to the region in which they are located.

According to a possible feature, the dielectric material body has a central region and a peripheral region, the size of the gas cavities (or alveolus) increasing or decreasing along a direction extending from the central region to the peripheral region in order to correspond to a decrease or increase in permittivity of the dielectric material body in said direction.

According to another possible feature, the dielectric material body has a central region and a peripheral region, the local number of the gas cavities (or alveolus) per volume unit increasing or decreasing along a direction extending from the central region to the peripheral region in order to correspond to an increase or decrease in permittivity of the dielectric material body in said direction.

Another aspect is the use of a dielectric material body in accordance with any of the above-mentioned aspects. Using such a dielectric material body for manufacturing an electromagnetic lens is one among many possible uses.

According to still another aspect, the invention also concerns an electromagnetic lens, comprising a dielectric material body wherein said dielectric material body has a predefined variation in dielectric permittivity. The new type of dielectric material body is well-suited to be used as an electromagnetic lens. However, many other technical applications are possible.

According to a further aspect, the invention also concerns an antenna comprising an electromagnetic lens being a dielectric material body that has a predefined variation in dielectric permittivity. The new type of dielectric material body is also well-suited to be used in antenna systems where said dielectric material body is used as an electromagnetic lens. However, many other industrial applications are possible.

According to another aspect, the invention also concerns a method of manufacturing an electromagnetic lens composed of a dielectric material body and an enclosure, the method comprising steps of shaping and forming the dielectric material body and enclosing the shaped and deformed dielectric material body by an enclosure.

According to a possible feature of this manufacturing method, the enclosure may comprise metallic material adapted to guide the electromagnetic waves when propagating through the electromagnetic lens. As already mentioned, soft dielectric material bodies need to be encapsulated (at least partially) by an enclosure to mechanically maintain the dielectric material body. In such a case, a metallic enclosure may also have an additional function of guiding the electromagnetic waves when propagating through the lens.

According to an alternative possible feature of the manufacturing method of an electromagnetic lens, the enclosure may comprise plastic material and at least one electromagnetically shielding member that is a metalized part of the enclosure boundary portion.

According to another aspect, the invention also concerns the manufacturing of an antenna comprising an electromagnetic lens manufactured according to any one of the foregoing methods.

Other features and advantages will emerge from the following description, given by way of a non-limiting example with reference to the accompanying drawings in which:

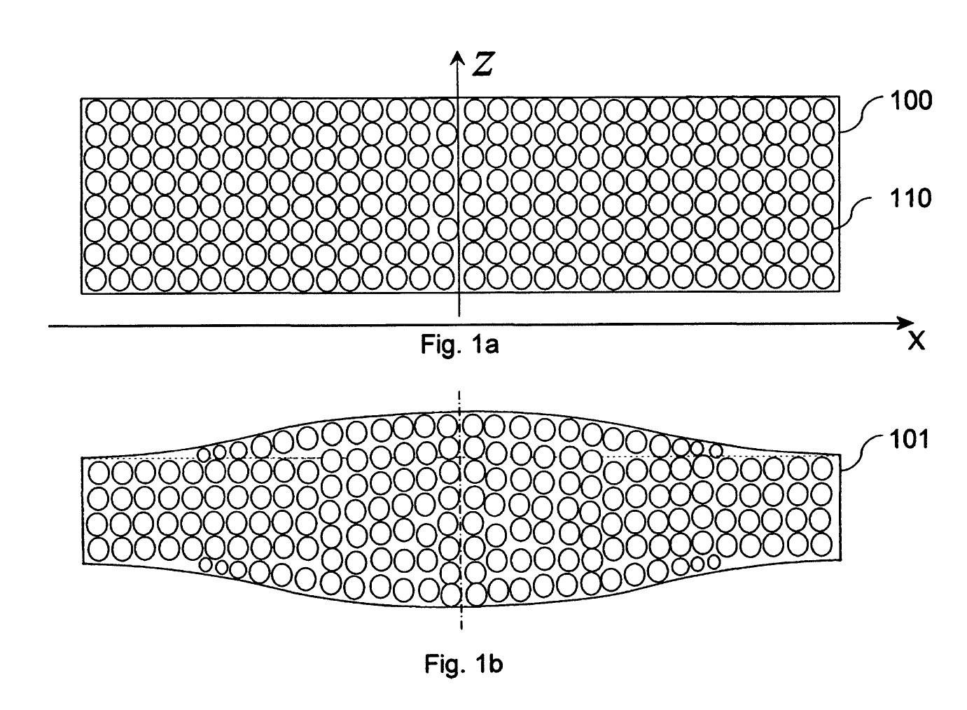

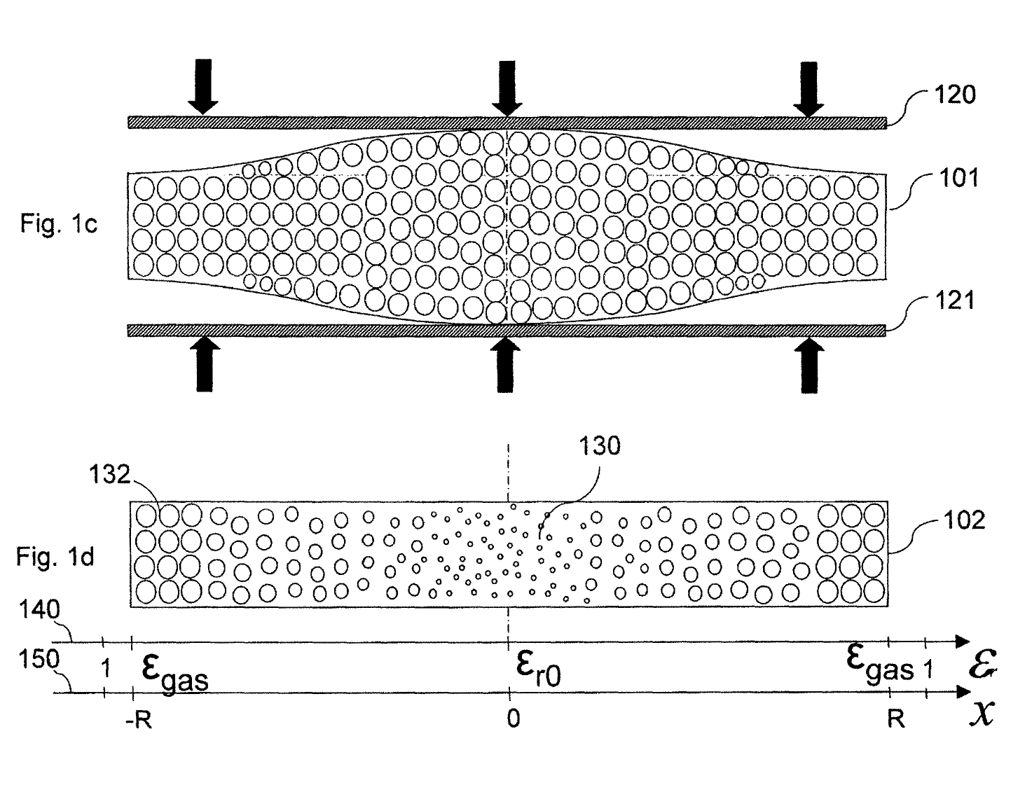

FIGS. 1a-d illustrate a method of manufacturing a dielectric material body according to an embodiment of the invention;

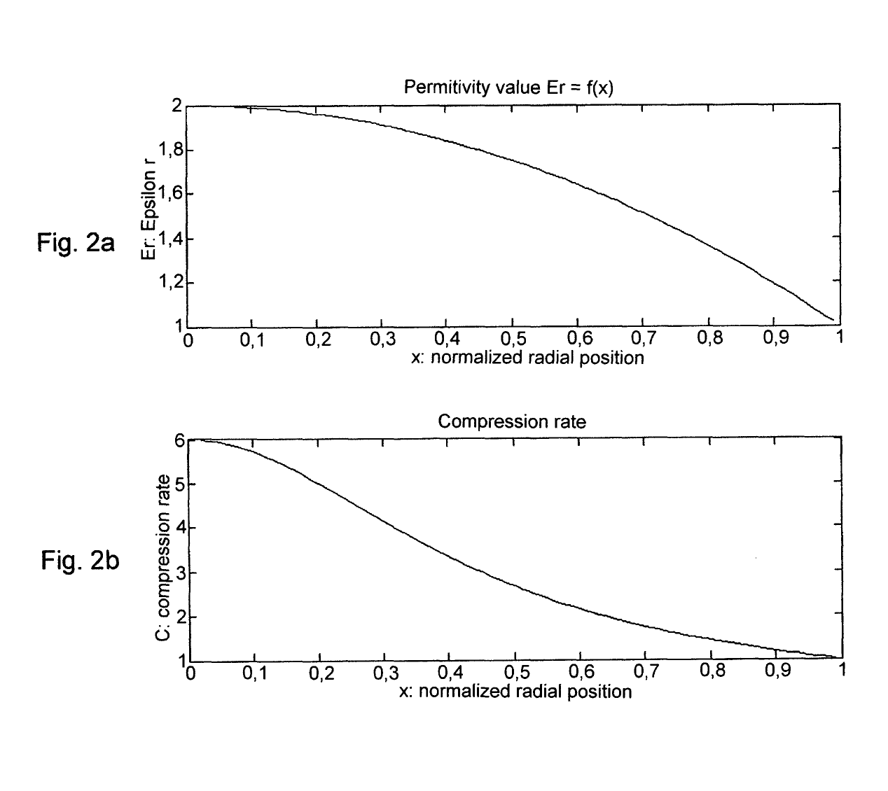

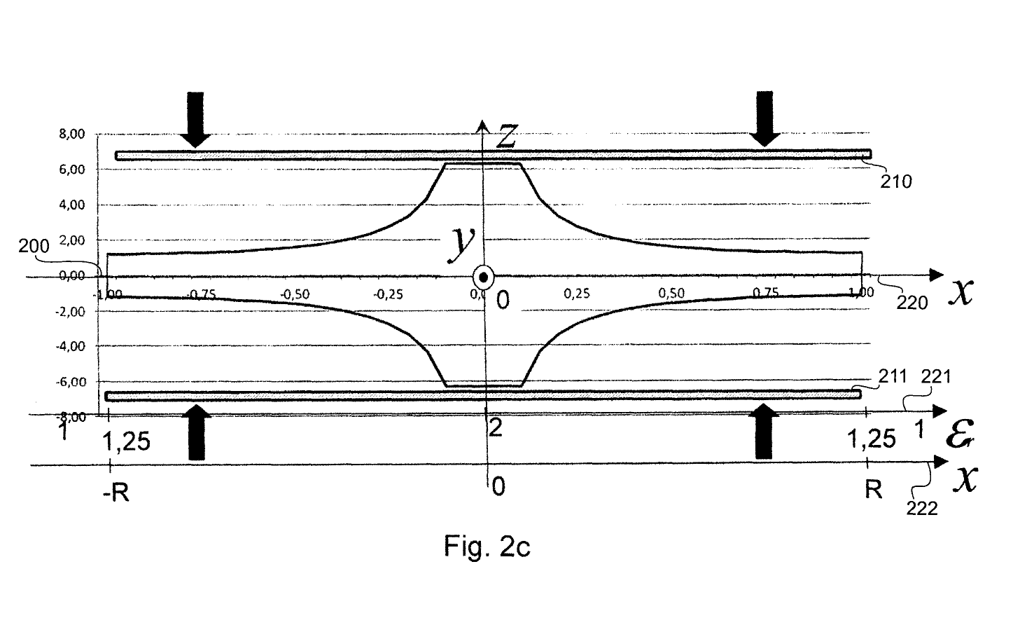

FIG. 2a represents the variation in dielectric permittivity according to the Lüneburg law;

FIG. 2b represents the compression rate to be followed for manufacturing a dielectric material body and having a permittivity corresponding to the Lüneburg law;

FIG. 2c illustrates the shape of a dielectric body that has been shaped according to the Lüneburg law before being compressed;

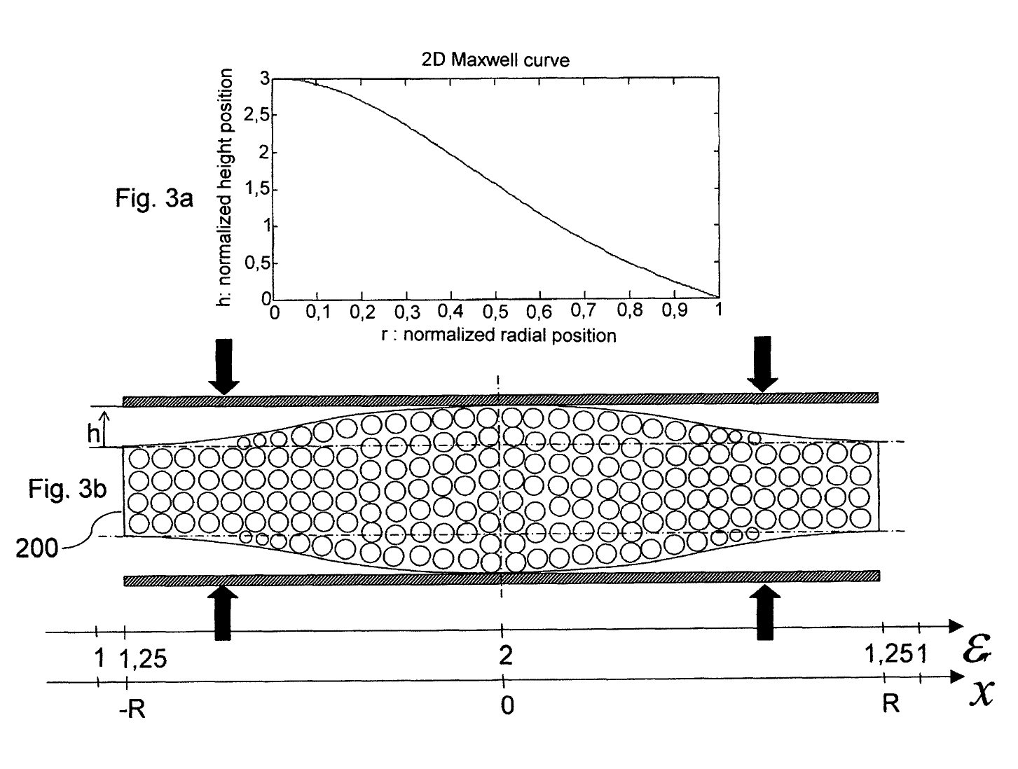

FIGS. 3a and 3b illustrate a method of manufacturing a dielectric material body having a permittivity corresponding to the Maxwell law;

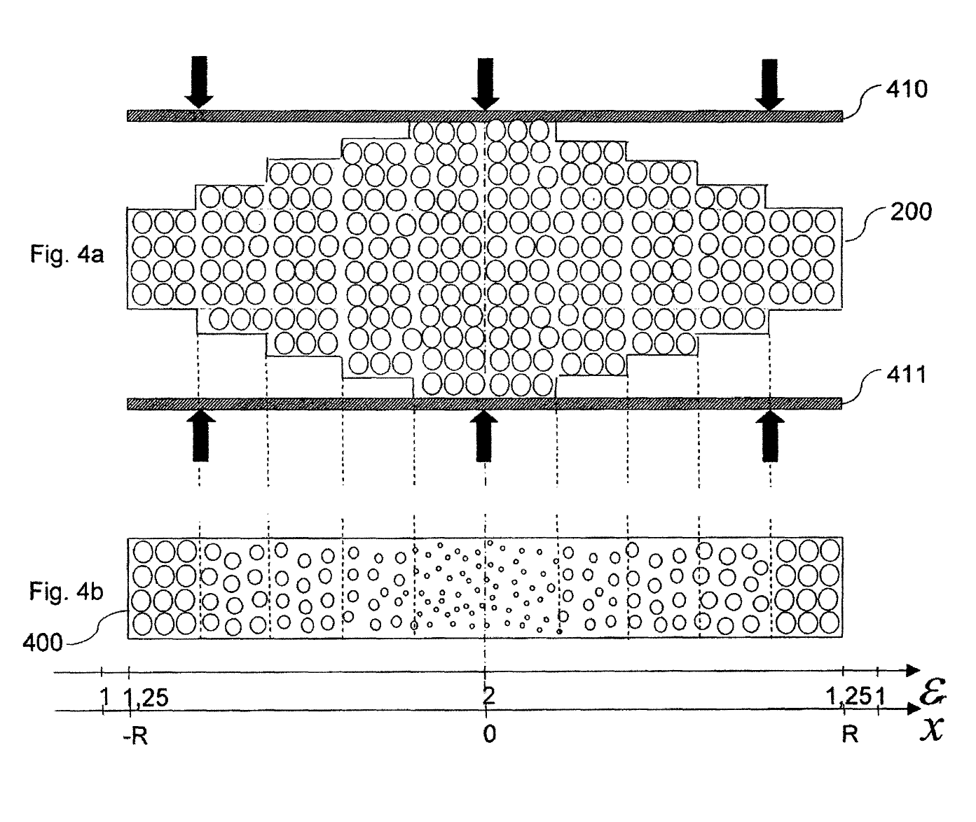

FIGS. 4a and 4b illustrate a method of manufacturing a dielectric material body according to a discrete approximation of a desired variation in permittivity;

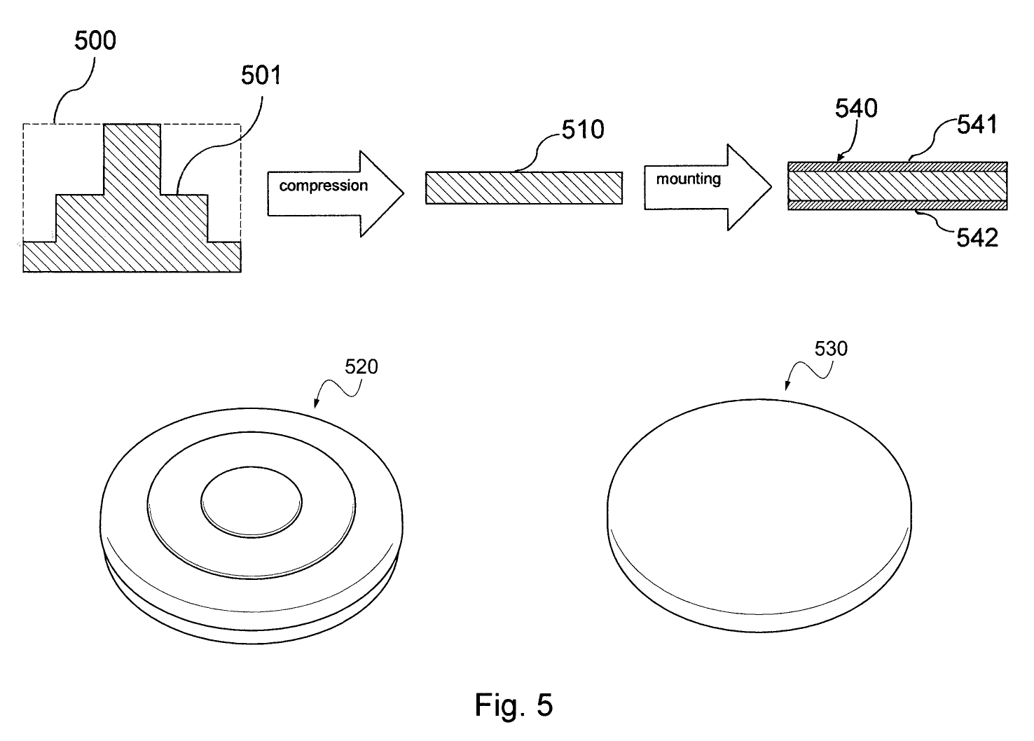

FIG. 5 illustrates the manufacturing of an electromagnetic lens starting from a block of rigid foam material; and

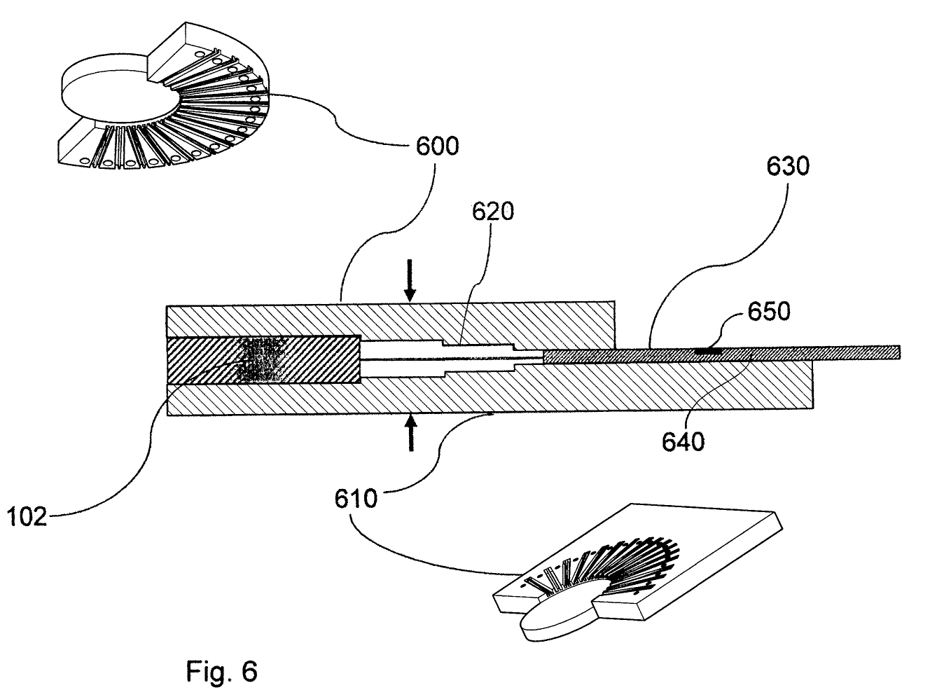

FIG. 6 illustrates a possible arrangement of the various components of an electromagnetic lens in an antenna system according to the invention.

A method of manufacturing a dielectric material body having a predefined variation in dielectric permittivity will now be described in accordance with a general embodiment of the invention.

According to this embodiment, the body is manufactured from a single dielectric material block or piece which does not result from the assembly or superposition of several blocks, parts or layers.

Said dielectric material block can possibly be composed either of soft (elastic) dielectric material or rigid (non-elastic) dielectric material.

Examples of dielectric material are the DIVINYCELL H or ROHACELL IG, A, HF and WF depending on the used press machine model and its performance in term of pressure and temperature, and depending of the size of the lens in case the application is directed to an electromagnetic lens. For more information on these materials the following websites may be consulted: http://www.diabgroup.com/europe/products/e_divinycell_f.html, and http://www.rohacell.com/product/rohacell/en/about/pages/default.aspx.

The first steps of the manufacturing method are illustrated in FIGS. 1a-b starting from a single dielectric material block. FIGS. 1c-d further complete the illustration of said manufacturing method.

The manufacturing method may be applied starting from either soft or rigid dielectric material block.

By way of example, this method may be used for manufacturing an electromagnetic lens. For example, such a manufactured lens can be integrated into an antenna system comprising radiating antenna elements, wave guides, and a casing.

In a first step of the manufacturing method as illustrated in FIG. 1a, a single homogeneous foam plate or block 100 composed either of soft or rigid dielectric material comprising gas cavities or alveolus 110 is provided. The foam plate 100 is represented in a cross section according to the Z-axis and extends along the X-axis. The relative dielectric permittivity ∈ᵣ of the foam 100 can be evaluated through the following equation:

∈ᵣ=(∈_{gas}*Z_{g}+∈ᵣ₀*Zₘ)/(Z_{g}+Zₘ)

where ∈_{gas} stands for the permittivity of the gas contained in the cavities 110 and ∈ᵣ₀ represents the permittivity of the material in between the gas cavities. Furthermore, the symbol Z_{g} represents the sum of the dimensions of each cavity present in a cross-section of the foam according to the Z-axis and Zₘ stands for the total thickness of the foam according to the Z-axis but without the sum Z_{g}. The gas confined in the cavities may be air, carbon dioxide, nitrogen or any other gas having a permittivity close to that of vacuum. The cavities may also be void, in which case the permittivity of the cavities is ∈₀=1.

In a subsequent step of the manufacturing method, the foam plate 100 (dielectric material body) is shaped in at least one direction by transposition of, or in accordance with the desired law of variation in permittivity as illustrated in FIG. 1b.

As represented in FIG. 1b, the height of the peripheral zone or edges of block 100 has been reduced by cutting away material so as to keep the central zone higher than the peripheral zone, with a smooth decrease in height. Thus, the variation in height is hereby adjusted. The shaped foam plate 101 may be obtained through moulding the original foam plate or block 100.

The next step is a step of forming at least partially the shaped foam plate.

In this step the shaped foam plate 101 is deformed by applying compression forces thereto. In some cases it may also be heated prior to and during the compression phase, as will be detailed hereinafter.

Mechanical pressure may be applied in several directions and on several parts of the dielectric material body. For the sake of simplification here, the shaped foam plate 101 is compressed in the direction of the Z-axis only. Consequently, the gas cavities may assume the shape of ellipsoids or even take on randomly defined forms that are flattened in the Z-direction.

In case the foam is also heated prior to and during the compression, then gas contained in the cavities may leave said cavities, thereby avoiding undesired significant radial deformation. This makes it possible to control the shape and dimensions of the cavities. The maximum dimension of the gas cavities needs to be controlled, in particular when said dielectric material is to be used e.g. as electromagnetic lens. In such a case the maximum dimension should not exceed one tenth of the wavelength used to radiate the electromagnetic lens. Control of the temperature enables control of the gas cavities shape and dimensions.

FIG. 1c illustrates an implementation of compression forces exerted by an upper plate 120 and a lower plate 121 disposed on either upper and lower sides of the shaped plate 101. FIG. 1c illustrates the situation before the compression forces are applied.

In case the dielectric material is soft, then foam plate 101 takes on the rectangular form 102 represented in cross-section in FIG. 1d as soon as le compression has started. The shaped foam plate 101 is being elastically deformed between the two plates 120 and 121 that get closer to each other following the directions of the arrows. Then the two plates 120 and 121 need to be permanently kept in place so as to form an enclosure for the foam plate 102. More particularly, the two plates are fastened to deformed and shaped foam plate 102, e.g. by gluing, so as to fix the dielectric material body.

The foam plate 102 contained in this mechanical enclosure has a predefined variation in permittivity.

In case the dielectric material is rigid then foam plate 101 needs first to be heated up so as to be softened. Once the compression has started, the heated and shaped foam plate 101 is then permanently deformed (beyond elasticity) between the two plates 120 and 121 that get closer to each other following the directions of the arrows. The foam plate 102 takes on the rectangular form represented in cross-section in FIG. 1d. This deformation is permanent after cooling down and the plates 120 and 121 can be removed. The foam plate 102 has a predefined variation in permittivity.

It is to be noted that when the foam plate or block is soft, additional lateral plates (not represented) are disposed against the lateral sides thereof of plate 101 (these lateral sides of plate 101 are adjacent to upper and lower sides that will be in contact with plates 120 and 121 respectively) in order to prevent the foam material from further deforming along the X-axis direction (undesired radial deformation) beyond the length of plates 120 and 121 (diameter of 2R).

Such additional lateral plates may also be used when the rigid dielectric material has been softened before being shaped.

The volume of the cavities near the central region (the value x of the volume is close to the 0 value along the X-axis 150) of the shaped and deformed foam plate has decreased and the permittivity thereof is close to ∈ᵣ₀, while in the peripheral regions (the value x of the volume is close to the values—R and R along the X-axis 150) the permittivity of the shaped and deformed foam plate is close to ∈_{gas}. The resulting permittivity ∈ᵣ of the shaped and deformed foam plate is represented on axis 140 in correspondence with X-axis 150 (FIG. 1d).

As represented in FIG. 1d, the variation or gradient in permittivity takes place in a single homogeneous material and the resulting dielectric material body 102 is not a superposition or assembly of any type of several materials having different permittivity values. The dielectric material body 102 comprises gas cavities or alveolus of variable size in the direction of the X-axis.

The variation in size of the gas cavities or alveolus is adapted to substantially correspond to the predefined law of variation in permittivity in at least one direction of the dielectric material body. The dielectric material body 102 is characterized by a predefined variation in dielectric permittivity. Dielectric material body 102 has at least two regions with gas cavities or alveolus in each region. One region has gas cavities with at least one size that is different from the size or sizes of the gas cavities in the other region. This other region may be adjacent to the first region.

In particular, the dielectric material body 102 has a central region 130 and a peripheral region 132. The size of the gas cavities or alveolus is increasing along a direction that extends from the central region to the peripheral region in order to correspond to a decrease in permittivity of the dielectric material body in said direction.

Put it another way, the local number of the gas cavities or alveolus per volume unit decreases from the central region to the peripheral region in order to correspond to a decrease in permittivity of the dielectric material body in said direction.

As already mentioned in the foregoing, specific laws of dielectric permittivity may be used in the manufacturing method. By way of illustration, an implementation of the manufacturing method is described in order to manufacture a Lüneburg lens. The relative dielectric constant of the lens conforms to the following rule:

∈ᵣ(x)=2−x², for x belonging to [−1, . . . ,0, . . . ,1]

as illustrated in FIG. 2a and varies in accordance with the normalized radial position x in the lens. In order to determine the form of the foam plate to be adopted, the preceding equations generate a relation between Z_{g} and Zₘ as follows:

(∈_{gas}*Z_{g}+∈ᵣ₀*Zₘ)/(Z_{g}+Zₘ)=2−x², for x belonging to ]−1, 1[.

Representing the shape Z as the sum of Z_{g} and Zₘ the following function is obtained for each x value belonging to the interval ]−1, 1 [ and provides an accurate description of the shape of the foam:

Z(x)=Zm*(1+(2−∈ᵣ₀−x2)/(x2−1)), for x belonging to ]−1,1 [.

In the remainder of the description, by way of simplification, ∈_{gas}=1 and ∈ᵣ₀=2.2. Consequently, the compression rate Z(x)/Z_{g}(x) to apply is that obtained as illustrated in FIG. 2b.

The final shape of the foam plate 200 resulting from the shaping in conformity with the desired law of permittivity (before compression by means of the two plates 210 and 211) is represented in FIG. 2c. A Cartesian coordinate system 220 is used here. Axis 221 and 222 having the same meaning as axis 140 and 150 in FIG. 1d are also used.

By further way of example, other laws of dielectric permittivity may be used in the manufacturing method of the invention.

For example, a Maxwell dielectric permittivity law is represented in FIG. 3a.

FIG. 3b shows a dielectric material body 200 being suitably shaped so as to induce a Maxwell law in the resulting shaped and deformed dielectric material body.

Further implementations of the manufacturing method according to the invention make it possible to achieve a variation in permittivity through discrete steps. In such a case the law of variation in permittivity is to be approximated by discrete steps which have been shaped (by cutting away) in a dielectric material body as shown in FIG. 4a. As for the previous embodiments the dielectric material body 200 is a single dielectric material block.

During compression of the shaped dielectric material body 200, the plates 410 and 411 are coming closer together and reach the position as illustrated in FIG. 4b. The resulting shaped and deformed dielectric material body 400 has a permittivity which varies by discrete steps through a monolithic continuum.

In case the dielectric material is rigid or non elastic, additional heating is necessary prior to and during the compression. After compression and cooling down the form of the foam plate 400 is permanent and the metal plates 410 and 411 can be removed.

In case of a soft dielectric material, after compression the foam plate needs to be fixed or maintained within the enclosure comprising the plates 410 and 411. These plates are fastened or fixed to the foam plate, e.g. by gluing.

In both cases this achievement corresponds to a dielectric material body having different regions of dielectric permittivity in geometric correspondence with the location of the discrete steps or shoulders of FIG. 4a without having any risk of air gaps between the regions as the material body is formed from a single material piece or part and is perfectly continuous. Put it another way, it may be considered as a monolithic continuum.

FIG. 5 illustrates the manufacturing of a dielectric material body having a stepwise variation in dielectric permittivity. A block 500 of rigid dielectric material of DIVINYCELL type is first shaped to obtain the stepped form 501. By way of example, the material is subsequently heated up to approximately 60 degrees Celsius and subsequently compressed by pressure forces of approximately ten bars and with a compression rate of 4. The compression plates are not shown here. The foam plate then takes on the resulting permanent form 510.

It is to be noted that the heating temperature which may be applied in all the above-described embodiments may lie within a range between 50 and 100 degrees Celsius depending on the material. Pressure to be applied may be between 7 and 15 bars. Other types of dielectric material may be used depending on the applications.

The view 520 illustrates the top view of the foam plate 510, while view 530 illustrates the bottom view thereof. The foam plate 510 may possibly be mounted within a mechanical enclosure referenced 540 and comprising the top 541 and bottom plates 542. The enclosed foam plate 540 can then be used as an electromagnetic lens. In case the top 541 and bottom plates 542 comprise metallic material, then the mechanical enclosure also guides the electromagnetic waves in the lens.

More generally, the shaped and deformed dielectric material body which has been manufactured according to the above-described embodiments of the method may be used in many different applications.

In one particular application, the manufactured dielectric material body is used as an electromagnetic lens that can be integrated in an antenna system. In such a case, the manufactured body is at least partially encapsulated by an enclosure that compresses the soft dielectric material body or simply encloses the rigid dielectric material body. This enclosure is advantageously made of two plates composed of metallic material. Alternatively, the enclosure may also comprise plastic material having at least one metalized part on the boundary portion disposed between the plastic part of the enclosure and the body, the metalized part playing the role of an electromagnetic shielding member.

FIG. 6 illustrates dielectric material body 102 of FIG. 1d encapsulated within an enclosure.

In FIG. 6, the enclosure comprises two metallic plates being a top plate 600 and a bottom plate 610 encapsulating the shaped and deformed dielectric material body 102. Plates 600 and 610 are fixed one to another to firmly maintain the electromagnetic lens therebetween. Both parts 600 and 610 are for example assembled together by screws, that are not shown in FIG. 6.

Furthermore, as illustrated in the cross section of FIG. 6, the metallic part of the enclosure comprises a ridged waveguide 620 formed between the micro-strip lines 630 and the dielectric material body 102. The waveguide transforms the RF electrical signal coming from the electronic components 650 disposed on the substrate 640 via the micro-strip lines 630 into an electromagnetic RF signal which is radiated through the electromagnetic lens 102 as an antenna element.

1. A method of manufacturing a dielectric material body having a predefined variation in dielectric permittivity in at least one direction, the method comprising steps of:
shaping in at least one direction at least one part of a dielectric material body, and
forming at least partially the shaped dielectric material body, said steps being adapted so that the shaped and formed dielectric material body has a predefined variation in dielectric permittivity in said at least one direction.

2. The manufacturing method according to claim 1, wherein the forming step comprises a sub-step of deforming at least partially the shaped dielectric material body.

3. The manufacturing method according to claim 2, wherein the forming step comprises a sub-step of fixing the thus shaped dielectric material body.

4. The manufacturing method according to claim 2, wherein the deforming sub-step comprises the application of compression forces on at least one part of the shaped dielectric material body.

5. The manufacturing method according to claim 4, wherein the shaped dielectric material body is at least partially enclosed by an enclosure that compresses at least partially the deformed dielectric material body.

6. The manufacturing method according to claim 5, wherein the enclosure encapsulating at least partially the shaped dielectric material body comprises at least two plates compressing together at least partially the deformed dielectric material body.

7. The manufacturing method according to claim 5, wherein the fixing sub-step of fixing the dielectric material body comprises fastening together at least two parts composing the enclosure.

8. The manufacturing method according to claim 2, wherein the deforming sub-step comprises the application of dilatation or expansion forces on at least one part of the shaped dielectric material body.

9. The manufacturing method according to claim 2, wherein the deforming sub-step comprises heating of at least one part of the shaped dielectric material body.

10. The manufacturing method according to claim 1, wherein the shaping step comprises cutting away at least one part of the dielectric material body in at least one direction.

11. The manufacturing method according to claim 1, wherein the shaping step comprises molding of at least one part of the dielectric material body in at least one direction.

12. The manufacturing method according to claim 1, wherein the dielectric material is substantially homogeneous and the shape of the dielectric material body is chosen so as to be substantially correlated with the variation in permittivity to be achieved in at least one direction of said dielectric material body.

13. The manufacturing method according to claim 1, wherein the dielectric material is a foam material.

14. The manufacturing method according to claim 1, wherein the dielectric material body has a cylindrical shape.

15. The manufacturing method according to claim 14, wherein the shaping step of at least one part of the dielectric material body in at least one direction comprises adjusting the variation in height of the cylindrical dielectric material body in said at least one direction, in order for said variation to substantially correspond to the predefined law of variation in permittivity of the dielectric material body.

16. The manufacturing method according to claim 15, wherein the shaping step of at least one part of the dielectric material body in at least one direction comprises adjusting the variation in height of the cylindrical dielectric material body in said at least one direction in order for said variation to substantially correspond to a discrete approximation of the predefined law of variation in permittivity of the dielectric material body.

17. A dielectric material body made of a single dielectric material body and having a predefined variation in dielectric permittivity.

18. A dielectric material body according to claim 17, wherein said dielectric material body comprises gas cavities of variable size in at least one direction.

19. A dielectric material body according to claim 18, wherein the variation in size of the gas cavities is adapted to substantially correspond to the predefined law of variation in permittivity in at least one direction of the dielectric material body.

20. A dielectric material body according to claim 18, wherein the variation in size of the gas cavities is adapted to substantially correspond to a discrete approximation of a given law of variation in permittivity in at least one direction of the dielectric material body.

21. A dielectric material body according to claim 17, wherein said dielectric material body comprises gas cavities and has at least two regions with gas cavities of different size in each region.

22. A dielectric material body according to claim 21, wherein the gas cavities have been previously compressed or expanded differently according to the region in which they are located.

23. A dielectric material body according to claim 18, wherein the dielectric material body has a central region and a peripheral region, the size of the gas cavities increasing or decreasing along a direction extending from the central region to the peripheral region in order to correspond to a decrease or increase in permittivity of the dielectric material body in said direction.

24. A dielectric material body according to claim 17, wherein the dielectric material body has gas cavities, a central region and a peripheral region, the local number of the gas cavities per volume unit increasing or decreasing along a direction extending from the central region to the peripheral region in order to correspond to an increase or decrease in permittivity of the dielectric material body in said direction.

25. (canceled)

26. An electromagnetic lens comprising a dielectric material body wherein said dielectric material body has a predefined variation in dielectric permittivity according to claim 17.

27. An antenna comprising an electromagnetic lens according to claim 26.

28. (canceled)

29. (canceled)

30. The manufacturing method according to claim 33, wherein the enclosure comprises metallic material adapted to guide the electromagnetic waves when propagating through the electromagnetic lens.

31. The manufacturing method according to claim 33, wherein the enclosure comprises plastic material and at least one electromagnetically shielding member that is a metalized part of the enclosure boundary portion.

32. An antenna comprising an electromagnetic lens wherein said electromagnetic lens is manufactured according to the method of claim 33.

33. A method for manufacturing an electromagnetic lens according to claim 26, wherein the method comprises a step of enclosing the shaped dielectric material body by an enclosure that compresses at least partially the deformed dielectric material body.

34. The manufacturing method according to claim 33, wherein the enclosure encapsulating at least partially the shaped dielectric material body comprises at least two plates compressing together at least partially the deformed dielectric material.

35. The manufacturing method according to claim 33, comprising a step for fastening together at least two parts composing the enclosure.

36. A method of manufacturing an electromagnetic lens composed of a dielectric material body and an enclosure, comprising the steps of:
shaping in at least one direction at least part of a dielectric material body;
forming at least partially the shaped dielectric material body,
said steps being adapted so that the shaped and formed dielectric material body has a predefined variation in dielectric permittivity in said at least one direction, wherein the forming step comprises a sub-step of deforming at least partially the shaped dielectric material body and the deforming sub-step comprises the application of compression forces on at least one part of the shaped dielectric material body, and wherein the shaped dielectric material body is at least partially enclosed by an enclosure that compresses at least partially the deformed dielectric material body.

37. The manufacturing method according to claim 36, wherein the forming step comprises a sub-step of fixing the thus-shaped dielectric material body.

38. The manufacturing method according to claim 36, wherein the enclosure encapsulating at least partially the shaped dielectric material body comprises at least two plates compressing at least partially he deformed dielectric material body.

39. The manufacturing method according to claim 36, wherein the fixing sub-step of fixing the dielectric material body comprises fastening together at least two parts composing the enclosure.

40. The manufacturing method according to claim 36, wherein the deforming sub-step comprises the application of dilation or expansion forces on at least one part of the shaped dielectric material body.

41. The manufacturing method according to claim 36, wherein the deforming sub-step comprises heating of at least one part of the shaped dielectric material body.

42. The manufacturing method according to claim 36, wherein the shaping step comprises cutting away at least one part of the dielectric material body in at least one direction.

43. The manufacturing method according to claim 36, wherein the shaping step comprises molding of at least one part of the dielectric material body in at least one direction.

44. The manufacturing method according to claim 36, wherein the dielectric material is substantially homogeneous and the shape of the dielectric material body is chosen so as to be substantially correlated with the variation in permittivity to be achieved in at least one direction of said dielectric material body.

45. The manufacturing method according to claim 36, wherein the dielectric material is a foam material.

46. The manufacturing method according to claim 36, wherein the dielectric material body has a cylindrical shape.

47. The manufacturing method according to claim 46, wherein the shaping step of at least one part of the dielectric material body in at least one direction comprises adjusting the variation in height of the cylindrical dielectric material body in said at least one direction, in order for said variation to substantially correspond to the predefined law of variation in permittivity in the dielectric material body

48. The manufacturing method according to claim 46, wherein the shaping step of at least one part of the dielectric material body in at least one direction comprises adjusting the variation in height of the cylindrical dielectric material body in said at least one direction in order for said variation to substantially correspond to a discrete approximation of the predefined law of variation in permittivity of the dielectric material body.

49. The manufacturing method according to claim 36, wherein the enclosure comprises metallic material adapted to guide the electromagnetic waves when propagating through the electromagnetic lens.

50. The manufacturing method according to claim 36, wherein the enclosure comprises plastic material and at least one electromagnetically-shielding member that is a metallized part of the enclosure boundary portion.

51. An antenna comprising an electromagnetic lens, wherein said electromagnetic lens is manufactured according to the method of claim 36.
